(19) United States
(12) Patent Application Publication
(10) Pub. No.: US 2025/0215205 A1
(43) Pub. Date: Jul. 3, 2025

(54) LOW DIELECTRIC RESIN COMPOSITION FOR IMPROVEMENT OF PROCESSABILITY, PREPREG AND METAL CLAD LAMINATE

(71) Applicant: NAN YA PLASTICS CORPORATION, TAIPEI (TW)

(72) Inventors: TE-CHAO LIAO, TAIPEI (TW); WEI-RU HUANG, TAIPEI (TW); HUNG-YI CHANG, TAIPEI (TW); CHIA-LIN LIU, TAIPEI (TW); Ren-Yu Liao, New Taipei City (TW)

(21) Appl. No.: 18/614,821

(22) Filed: Mar. 25, 2024

(30) Foreign Application Priority Data
Dec. 27, 2023 (TW) 112150954

(51) Int. Cl. C08L 25/10; B32B 15/08; C08K 3/36; C08K 5/00

(52) U.S. Cl. CPC C08L 25/10; B32B 15/08; C08K 3/36; C08K 5/0066; C08L 2205/20

(57) ABSTRACT

A low dielectric resin composition for improvement of processability includes a resin system, a halogen-free flame retardant, hollow spherical silica, and a coupling agent. The resin system includes a polyphenylene ether resin, a crosslinking agent, and a vinyl-containing elastomer which are each added in a specific weight percentage. The hollow spherical silica has a specific gravity between 0.4 g/cm³ and 0.6 g/cm³ and an average particle size (D50) between 2.0 μm and 3.0 μm. Therefore, the low dielectric resin composition after being cured has a dielectric constant (Dk) between 2.75 and 3.05 and a dielectric loss factor (Df) of less than 0.002 at 10 GHz. Based on the above, a prepreg and a metal clad laminate applying the low dielectric resin composition are further provided.

### CROSS-REFERENCE TO RELATED PATENT APPLICATION

This application claims the benefit of priority to Taiwan Patent Application No. 112150954, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition and its applications, and more particularly to a low dielectric resin composition for improvement of processability and a prepreg and a metal clad laminate made by using the low dielectric resin composition.

### BACKGROUND OF THE DISCLOSURE

Advanced driver assistance system (ADAS) enables drivers to have enough time to respond to traffic conditions, thereby allowing car accidents to be prevented. With the improvement of technology and the decrease in cost of the millimeter wave radar (mmWave radar), the millimeter wave radar has achieved a level of important in the field of ADAS sensors, and can be used to sense the surrounding environment around a car at any time during driving.

Substrates used for the millimeter wave radar are mainly divided into fluororesin substrates and thermosetting resin substrates. A substrate made of a fluororesin may have difficulty in drilling and copper plating due to the characteristics of the fluororesin (e.g., poor processability of PTFE) when used for manufacturing a laminated board which requires special manufacturing and processing equipment, thus causing the problem of high costs. In addition, since fluororesin is a thermoplastic resin, a fluororesin-based electronic material is difficult to be molded in combination with an electronic material adopting a thermosetting resin (e.g., an epoxy resin). Therefore, usage of the fluororesin-based electronic material is limited in practical applications. While hollow glass beads can be introduced into a thermosetting resin substrate to reduce the dielectric constant (Dk) to a lower level, the hollow glass beads can not only cause poor plated copper uniformity of drilled hole, but also cause an increase in Df value.

### SUMMARY OF THE DISCLOSURE

In response to the above-referenced technical inadequacies, the present disclosure provides a low dielectric resin composition for improvement of processability, which is advantageous for low transmission loss and processability of electronic materials, so as to meet the requirements of millimeter wave applications. The present disclosure further provides a prepreg and a metal clad laminate applying the low dielectric resin composition.

In order to solve the above-mentioned problems, one of the technical aspects adopted by the present disclosure is to provide a low dielectric resin composition for improvement of processability, which includes component (A) of a resin system, component (B) of a halogen-free flame retardant, component (C) of hollow spherical silica, and component (D) of a coupling agent. The resin system includes 10 wt % to 60 wt % of a polyphenylene ether resin, 5 wt % to 30 wt % of a crosslinking agent, and 20 wt % to 50 wt % of a vinyl-containing elastomer, based on a total weight of the resin system. The hollow spherical silica has a specific gravity between 0.4 g/cm³ and 0.6 g/cm³ and an average particle size (D50) between 2.0 μm and 3.0 μm. In the low dielectric resin composition, with respect to 100 phr of the resin system, an amount of the halogen-free flame retardant ranges from 20 phr to 45 phr, an amount of the hollow spherical silica ranges from 5 phr to 15 phr, and an amount of the coupling agent ranges from 0.1 phr to 5 phr. Furthermore, the low dielectric resin composition after being cured has a dielectric constant (Dk) between 2.75 and 3.05 and a dielectric loss factor (Df) of less than 0.002 at 10 GHz.

In one of the possible or preferred embodiments, the vinyl-containing elastomer is selected from the group consisting of polybutadiene, styrene-butadiene copolymer, styrene-butadiene-styrene block copolymer, and styrene-butadiene-divinylbenzene copolymer.

In one of the possible or preferred embodiments, the vinyl-containing elastomer is styrene-butadiene-styrene block copolymer that has a weight average molecular weight between 3500 g/mol and 5500 g/mol.

In one of the possible or preferred embodiments, an amount of the styrene unit of the styrene-butadiene-styrene block copolymer is between 5 mol % and 40 mol %. Furthermore, the styrene-butadiene-styrene block copolymer has a 1,2-vinyl content between 60 mol % and 90 mol % and a 1,4-vinyl content between 10 mol % and 40 mol %, based on a total vinyl content thereof being 100 mol %.

In one of the possible or preferred embodiments, the hollow spherical silica is surface-modified by at least one of an acrylic group and a vinyl group.

In one of the possible or preferred embodiments, the crosslinking agent is selected from the group consisting of 1,3,5-triallyl cyanurate (TAC), triallyl isocyanurate (TAIC), trimethallyl isocyanurate (TMAIC), diallyl phthalate, divinylbenzene, and 1,2,4-triallyl trimellitate.

In one of the possible or preferred embodiments, the low dielectric resin composition further includes component (E) of a general spherical silica that has a specific gravity between 2.0 g/cm³ and 2.5 g/cm³. Furthermore, with respect to 100 phr of the resin system, an amount of the general spherical silica is 85 phr to 95 phr.

In one of the possible or preferred embodiments, the general spherical silica has an average particle size (D50) between 2.0 μm and 3.0 μm.

In one of the possible or preferred embodiments, the halogen-free flame retardant is a compound having the structure represented by formula (I):

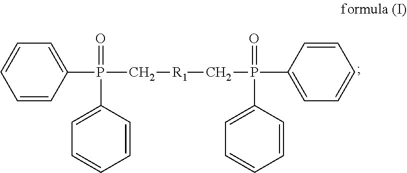

in formula (I), R1 represents a covalent bond, —CH2—,

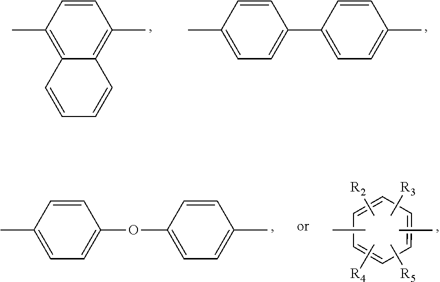

in which R₂, R₃, R₄, and R₅ each independently represent a hydrogen atom, an alkyl group, or

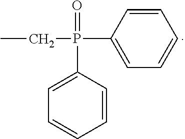 [SMILES: CCP(=O)(c1ccccc1)c1ccccc1]

In order to solve the above-mentioned problems, another one of the technical aspects adopted by the present disclosure is to provide a prepreg, which is prepared by coating or impregnating a reinforcing material with the low dielectric resin composition.

In order to solve the above-mentioned problems, yet another one of the technical aspects adopted by the present disclosure is to provide a metal clad laminate, which is prepared by laminating the prepreg to a metal layer or by coating the low dielectric resin composition on a metal layer.

In conclusion, by virtue of the resin system including 10 wt % to 60 wt % of a polyphenylene ether resin, 5 wt % to 30 wt % of a crosslinking agent, and 20 wt % to 50 wt % of a vinyl-containing elastomer, based on a total weight of the resin system, and the hollow spherical silica being in an amount from 1 phr to 20 phr and having a specific gravity between 0.4 g/cm³ and 0.6 g/cm³ and an average particle size (D50) between 2.0 μm and 3.0 μm, the low dielectric resin composition provided by the present disclosure can achieve excellent electrical properties (low Dk/low Df), moisture absorbance, and heat resistance while complying with halogen-free environmental protection requirements. Accordingly, the low dielectric resin composition can ensure stable performance on low transmission loss and exhibit good fluidity and resin filling property when used for manufacturing a laminated board, and is advantageous for improving drilling machinability and copper plating quality.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 and FIG. 2 are each a schematic view showing a practical application of a low dielectric resin composition for improvement of processability of the present disclosure; and

FIG. 3 to FIG. 5 are each a schematic view showing a metal clad laminate manufactured by using the low dielectric resin composition for improvement of processability of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Unless otherwise stated, the material(s) used in any described embodiment is/are commercially available material(s) or may be prepared by methods known in the art, and the operation(s) or instrument(s) used in any described embodiment is/are conventional operation(s) or instrument(s) generally known in the related art.

A substrate made of a fluororesin may have difficulty in drilling and copper plating due to the characteristics of the fluororesin when used for manufacturing a laminated board which requires special manufacturing and processing equipment, thus causing the problem of high costs. In addition, since fluororesin is a thermoplastic resin, a fluororesin-based electronic material is difficult to be molded in combination with an electronic material adopting a thermosetting resin (e.g., an epoxy resin). Therefore, the fluororesin-based electronic material is limited in practical applications and insufficient to meet the requirements of advanced applications such as 5th generation mobile communication, advanced driver assistance systems (ADAS), and artificial intelligence (AI). Therefore, the present disclosure provides an inventive concept as follows: a polyphenylene ether resin as a thermosetting resin is used in combination with a vinyl-containing elastomer, preferably styrene-butadiene-styrene block copolymer, and hollow spherical silica (SiO₂) having a predetermined specific gravity and particle size is introduced to achieve low dielectric properties without lowering practically required characteristics, such as processability, moisture absorbance, heat resistance, fluidity, and resin filling property.

More specifically, the present disclosure provides a low dielectric resin composition for improvement of processability, which embodies the inventive concept and includes: component (A), a resin system; component (B), a halogen-free flame retardant; component (C), hollow spherical silica, and component (D), a coupling agent. More details about each component are described below.

### Component (A) of Resin System

The resin system forming the low dielectric resin composition of the present disclosure includes 10 wt % to 60 wt % of a polyphenylene ether (PPE) resin, 5 wt % to 30 wt % of a crosslinking agent, and 20 wt % to 50 wt % of a vinyl-containing elastomer, based on a total weight of the resin system.

In one embodiment of the present disclosure, the polyphenylene ether resin has a molecule main chain that contains an unsaturated functional group at each of terminal ends, such as hydroxy, vinyl, styryl, vinylbenzyl, allyl, acryloyl, methacrylate, epoxy, and maleimide groups. Said unsaturated functional group means a group capable of undergoing an addition polymerization reaction with other components having an unsaturated functional group, and said addition polymerization reaction may be initiated by light or heat in the presence of a polymerization initiator.

More specifically, the polyphenylene ether resin used for the resin system as component (A) can be selected from the group consisting of the following: a polyphenylene ether resin containing terminal hydroxyl groups, a polyphenylene ether resin containing terminal vinyl groups, a polyphenylene ether resin containing terminal styryl groups, a polyphenylene ether resin containing terminal vinylbenzyl groups, a polyphenylene ether resin containing terminal allyl groups, a polyphenylene ether resin containing terminal acryloyl groups, a polyphenylene ether resin containing terminal methacrylate groups, a polyphenylene ether resin containing terminal epoxy groups, and a polyphenylene ether resin containing terminal maleimide groups. These polyphenylene ether resins can be used individually or in combination.

With respect to a total weight of the resin system being 100 wt %, an amount of the polyphenylene ether resin can be 10 wt %, 15 wt %, 20 wt %, 25 wt %, 30 wt %, 35 wt %, 40 wt %, 45 wt %, 50 wt %, 55 wt %, or 60 wt %. The polyphenylene ether resin can have a weight average molecular weight between 1000 g/mol and 20000 g/mol, and preferably between 1000 g/mol and 10000 g/mol. If the molecular weight of the polyphenylene ether resin is too large, the fluidity and solvent solubility of the polyphenylene ether resin may become worse. If the molecular weight of the polyphenylene ether resin is too small, the electrical properties and thermal stability of the resin composition may be negatively affected.

In practice, two different polyphenylene ether resins can be used in combination in the resin system as component (A), such as a polyphenylene ether resin having a molecule main chain with terminal maleimide groups and a polyphenylene ether resin having a molecule main chain with terminal hydroxy, styryl, methacrylate, or epoxy groups. Alternatively, three different polyphenylene ether resins can be used in combination in the resin system as component (A), such as a polyphenylene ether resin having a molecule main chain with terminal maleimide groups, a polyphenylene ether resin having a molecule main chain with terminal styryl groups, and a polyphenylene ether resin having a molecule main chain with terminal methacrylate groups.

In the presence of the above-mentioned polyphenylene ether resin(s) having an unsaturated functional group, the vinyl-containing elastomer can have improved compatibility in the resin composition. Accordingly, an upper limit for addition of the vinyl-containing elastomer in the resin composition can be increased. Preferably, in the resin system as component (A), the amount of polyphenylene ether resin is greater than that of vinyl-containing elastomers. The method for preparing the above-mentioned polyphenylene ether resin(s) having an unsaturated functional group is not a primary technical feature of the present disclosure, and people having ordinary skill in the art can carry out the method based on the present disclosure.

In one embodiment of the present disclosure, the double bond of the vinyl of the vinyl-containing elastomer can be used to react with an unsaturated functional group of the polyphenylene ether resin to form a covalent bond. Accordingly, the resin composition after being cured can have good low dielectric properties, heat resistance, and processability. It is worth mentioning that compared to the conventional low dielectric resin composition that uses a liquid rubber in combination with a polyphenylene ether resin, the low dielectric resin composition of the present disclosure that uses a vinyl-containing elastomer in combination with a polyphenylene ether resin can prevent phase separation.

More specifically, the vinyl-containing elastomer used for the resin system as component (A) can be selected from the group consisting of polybutadiene, styrene-butadiene copolymer, styrene-butadiene-styrene block copolymer, and styrene-butadiene-divinylbenzene copolymer. These vinyl-containing elastomers can be used individually or in combination.

With respect to the total weight of the resin system being 100 wt %, an amount of the vinyl-containing elastomer can be 20 wt %, 25 wt %, 30 wt %, 35 wt %, 40 wt %, 45 wt %, or 50 wt %. If the content of the vinyl-containing elastomer is less than 20 wt %, the resin composition cannot achieve desired electrical properties (e.g., low Dk and Df values) and physical and chemical properties (e.g., high glass transition temperature, low water absorption, and good heat resistance). If the content of the vinyl-containing elastomer is greater than 50 wt %, the functions or effects of other components in the resin composition would be inhibited, causing the resin composition to have some poor properties (e.g., poor flame resistance).

Preferably, the vinyl-containing elastomer is styrene-butadiene-styrene block copolymer that has a weight average molecular weight between 3500 g/mol and 5500 g/mol, for example, such as 3500 g/mol, 4000 g/mol, 4500 g/mol, 5000 g/mol, or 5500 g/mol. In consideration of the physical properties of the resin composition after being cured, an amount of the styrene unit of the styrene-butadiene-styrene block copolymer is between 5 mol % and 40 mol %, based on the total amount of all monomer units of the styrene-butadiene-styrene block copolymer being 100 mol %. Furthermore, the styrene-butadiene-styrene block copolymer has a 1,2-vinyl content between 60 mol % and 90 mol % and a 1,4-vinyl content between 10 mol % and 40 mol %, based on a total vinyl content thereof being 100 mol %. If the 1,2-vinyl content of the styrene-butadiene-styrene block copolymer is less than 60 mol %, the physical properties (e.g., glass transition temperature and heat resistance) of the resin composition after being cured may become worse.

In one embodiment of the present disclosure, the crosslinking agent is a component that has at least one unsaturated functional group containing a double or triple bond, so as to undergo a crosslinking reaction with the polyphenylene ether resin and the vinyl-containing elastomer to form a three-dimensional network structure. The crosslinking agent can be, but is not limited to, a monofunctional crosslinker that has only one unsaturated functional group in a molecule structure or a polyfunctional crosslinker that has more than two unsaturated functional groups in a molecule structure. There is no restriction on the type of the crosslinking agent, and the crosslinking agent is preferably one that has good compatibility with the polyphenylene ether resin and the vinyl-containing elastomer.

More specifically, the crosslinking agent used for the resin system as component (A) can be selected from the group consisting of 1,3,5-triallyl cyanurate (TAC), triallyl isocyanurate (TAIC), trimethallyl isocyanurate (TMAIC), diallyl phthalate, divinylbenzene, and 1,2,4-triallyl trimellitate. These crosslinking agents can be used individually or in combination.

With respect to the total weight of the resin system being 100 wt %, an amount of the crosslinking agent can be 5 wt %, 10 wt %, 15 wt %, 20 wt %, 25 wt %, or 30 wt %.

### Component (B) of Halogen-Free Flame Retardant

The halogen-free flame retardant forming the low dielectric resin composition of the present disclosure can be a phosphorus-containing flame retardant, so as to increase flame resistance of a resulting electronic material and meet the requirements of halogen-free environmental protection. In practice, the phosphorus-containing flame retardant can be selected from the group consisting of a phosphate ester flame retardant, a phosphazene flame retardant, a phosphine oxide flame retardant, ammonium polyphosphate, melamine polyphosphate, melamine phosphate, and 9,10-dihydro-9-oxa-10-phosphaphenanthrene-10-oxide (DOPO). These halogen-free flame retardants can be used individually or in combination. However, such examples are not intended to limit the present disclosure.

Specific examples of the phosphate ester flame retardant include triphenyl phosphate (TPP), tetraphenyl resorcinol bis(diphenylphosphate) (RDP), bisphenol A bis(diphenylphosphate) (BDP), and Resorcinol bis(di-2,6-xylyl phosphate) (RXP).

Specific examples of the phosphazene flame retardant include cyclic and linear phosphazene compounds.

Specific examples of the phosphine oxide flame retardant include tris(4-methoxyphenyl)phosphine oxide, diphenylphosphine oxide, triphenylphosphine oxide, and a phosphine oxide compound having the structure represented by formula (I) (the product with model name PQ-60 available from Chin-Yee Chemical Industries Co., Ltd.). It is worth mentioning that in addition to known flame-retardant properties, the phosphine oxide compound having the structure represented by formula (I) also functions to improve low dielectric properties of the resin composition, which is beneficial for high frequency applications.

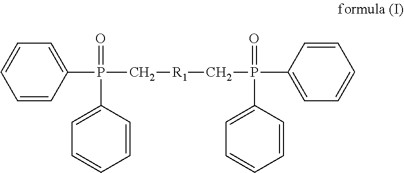

In formula (I), R₁ represents a covalent bond, —CH₂—,

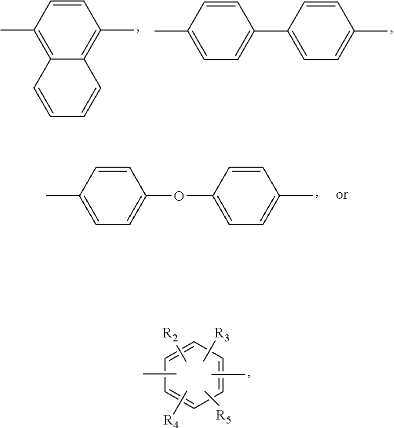

in which R₂, R₃, R₄, and R₅ each independently represent a hydrogen atom, an alkyl group, or

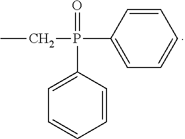 [SMILES: CCP(=O)(c1ccccc1)c1ccccc1]

With respect to 100 phr of the resin system as component (A), an amount of the halogen-free flame retardant as component (B) can be in the range from 20 phr to 45 phr, such as 20 phr, 25 phr, 30 phr, 35 phr, 40 phr, or 45 phr. If the amount of the halogen-free flame retardant is less than 20 phr, an electronic material made of the resin composition cannot achieve desired flame resistance. If the amount of the halogen-free flame retardant is greater than 45 phr, properties required for practical use may be negatively affected, such as electrical properties, water absorbance, and tear strength.

### Component (C) of Hollow Spherical Silica

The hollow spherical silica (SiO₂) for forming the low dielectric resin composition of the present disclosure has a predetermined specific gravity and particle size. Accordingly, the resin composition can exhibit good fluidity and good resin filling property (i.e., the ability to fill gaps completely) and has good low dielectric properties and good processability (i.e., drilling machinability) after being cured. Accordingly, the low dielectric resin composition of the present disclosure can produce beneficial effects required for a laminate, such as high-frequency and high-speed transmission and high copper plating quality.

More specifically, the hollow spherical silica as component (C) has a purity more than about 99%, a specific gravity between 0.4 g/cm³ and 0.6 g/cm³, and an average particle size (D50) between 2.0 μm and 3.0 μm. Furthermore, the hollow spherical silica as component (C) can be surface-modified by at least one of an acrylic group and a vinyl group, thereby having good compatibility to the resin system as component (A), and can thus be added to the resin composition in a greater amount without negatively affecting properties required for practical use.

With respect to 100 phr of the resin system as component (A), an amount of the hollow spherical silica as component (C) can be in the range from 1 phr to 20 phr, preferably from 5 phr to 15 phr, such as 1 phr, 2 phr, 3 phr, 4 phr, 5 phr, 6 phr, 7 phr, 8 phr, 9 phr, 10 phr, 11 phr, 12 phr, 13 phr, 14 phr, 15 phr, 16 phr, 17 phr, 18 phr, 19 phr, or 20 phr.

### Component (D) of Coupling Agent

The coupling agent forming the low dielectric resin composition of the present disclosure can be at least one of a silane compound and a siloxane compound, so as to increase interfacial bonding strength between a resin and a reinforcing material such as a fiber cloth and improve compatibility between the resin and inorganic powders.

Specific examples of the silane compound include amino silane, vinyl silane, acrylic silane, and epoxy silane. Specific examples of the siloxane compound include amino siloxane, vinyl siloxane, acrylic siloxane, and epoxy siloxane.

With respect to 100 phr of the resin system as component (A), an amount of the coupling agent as component (D) can be in the range from 0.1 phr to 5 phr, such as 0.1 phr, 0.5 phr, 1 phr, 1.5 phr, 2 phr, 2.5 phr, 3 phr, 3.5 phr, 4 phr, 4.5 phr, or 5 phr.

### Component (E) of Inorganic Filler

If necessary, the low dielectric resin composition of the present disclosure can further increase at least one inorganic filler as component (E), so as to improve mechanical strength, thermal conductivity, and heat resistance. In order to maintain the dielectric constant and dielectric loss at a lower level, the at least one inorganic filler can be selected from the group consisting of the following: general spherical silica different from the hollow spherical silica, aluminum oxide, zinc oxide, titanium oxide, magnesium oxide, antimony oxide, beryllium oxide, aluminum nitride, boron nitride, calcium carbonate, potassium titanate, glass fiber, barium titanate, barium sulfate, aluminum hydroxide, and magnesium hydroxide. These inorganic fillers can be used individually or in combination. However, such examples are not intended to limit the present disclosure.

With respect to 100 phr of the resin system as component (A), an amount of the at least one inorganic filler as component (E) can be in the range from 50 phr to 120 phr, such as 50 phr, 55 phr, 60 phr, 65 phr, 70 phr, 75 phr, 80 phr, 85 phr, 90 phr, 95 phr, 100 phr, 105 phr, 110 phr, 115 phr, or 120 phr.

Preferably, the at least one inorganic filler as component (E) is general spherical silica that can be prepared by using a synthesis method. Furthermore, the general spherical silica has a specific gravity between 2.0 g/cm³ and 2.5 g/cm³, preferably 2.2 g/cm³, and has an average particle size (D50) between 2.0 μm and 3.0 μm. With respect to 100 phr of the resin system, an amount of the general spherical silica is from 50 phr to 120 phr, and preferably from 85 phr to 95 phr.

### Prepreg and Metal Clad Laminate

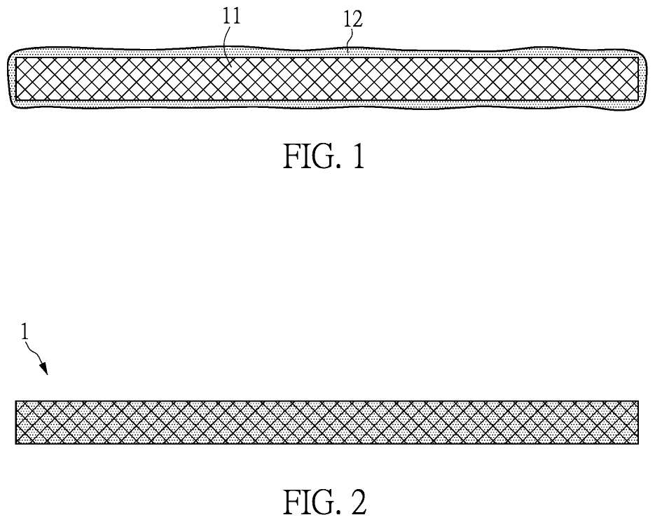

Referring to FIG. 1 and FIG. 2, the present disclosure further provides a prepreg 1 and a metal clad laminate applying the low dielectric resin composition as described above. More specifically, the prepreg 1 is prepared by the method as follows. The reinforcing material 11 is coated or impregnated with a low dielectric resin composition 12, in which the low dielectric resin composition 12 is attached to the reinforcing material 11. Afterwards, the low dielectric resin composition 12 is caused to be in a semi-cured state by heating at a high temperature. The reinforcing material 11 is, for example, an electronic-grade general-purpose fiberglass cloth.

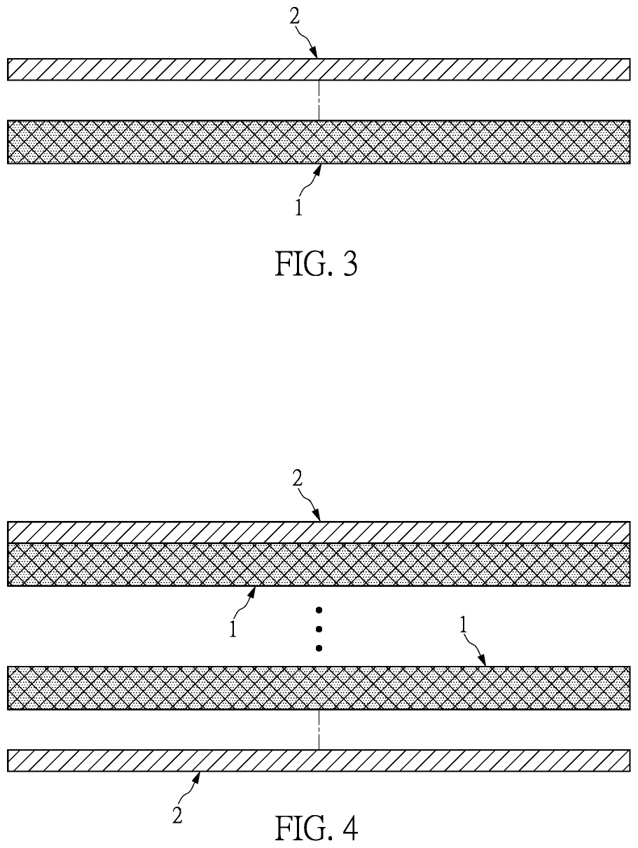

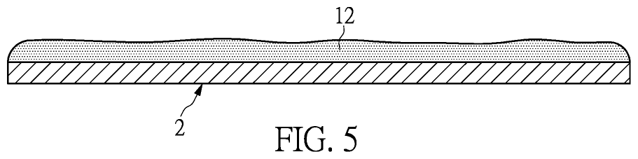

Referring to FIG. 3 to FIG. 5, the metal clad laminate can be prepared by the method as follows. One or more prepregs 1 are laminated with at least one metal layer 2 (e.g., a copper layer) and bonded together by hot pressing. Alternatively, the low dielectric resin composition 12 is coated on a metal layer 2 and cured after being fully dried. In one embodiment of laminating one or more prepregs 1 with at least one metal layer 2 (e.g., a copper layer), a number of prepregs 1 can be formed into a laminate’, and a metal layer 2 can be laminated on at least one outer side of the laminate 1’.

In practice, the metal layer 2 of the metal clad laminate can be patterned by conventional process steps to obtain a printed circuit board.

### Performance Evaluation

The resin compositions as shown in Table 1 and Table 2 are each formed into a thermosetting resin varnish by using toluene. Each of the resin compositions is used to impregnate four Nan-Ya fiber glass cloth (the product with model name NE1078 available from Nan Ya Plastics Corporation) serving as reinforcing materials at room temperature. After drying at 130° C. for a few minutes, the four prepregs resulting from each of the resin compositions are obtained and each have a resin content of 70 wt %. Afterwards, the four prepregs resulting from each of the resin compositions are laminated between two copper foils having a thickness of 35 μm for hot pressing. The hot pressing is carried out at a temperature of 85° C. and under a pressure of 25 kg/cm², and the temperature is maintained for 20 minutes. Next, the temperature is heated to 210° C. at a heating rate of 3° C./min, maintained for 120 minutes, and slowly cooled to 130° C. Thus, a copper foil substrate sample resulting from each of the resin compositions and having a thickness of 0.4 mm is obtained and evaluated for performance according to the following conditions.

Glass transition temperature (° C.): testing the glass transition temperature by a dynamic mechanical analyzer (DMA).

Water absorption rate (%): heating the copper foil substrate sample in a 2-atm pressure cooker at 120° C. for 120 minutes and calculating the change in weight loss of the copper foil substrate sample after heating.

Solder heat resistance (288° C.): after the copper foil substrate sample is heated in a 2-atm pressure cooker at 120° C. for 120 minutes, immersing the copper foil substrate sample in a solder bath at 288° C. and observing the copper foil substrate sample at ½ hour and 2 hours. If cracking or interlayer delamination in the copper foil substrate sample is observed, the copper foil substrate sample is regarded as “NG”. If no cracking or interlayer delamination in the copper foil substrate sample is observed, the copper foil substrate sample is regarded as “Pass”.

Dielectric constant (10 GHZ) and Dielectric dissipation factor (10 GHz): after the copper foils are removed from the copper foil substrate sample and a baking process in a 105° C. oven is subsequently performed on the sample for 30 minutes, detecting the dielectric constant and the dielectric dissipation factor of the copper foil substrate sample at 10 GHz by an dielectric analyzer (the product with model name E4991A available from Agilent Technologies, Inc).

Plated copper uniformity of drilled hole: after a hole drilling process is performed on the copper foil substrate sample, analyzing the copper foil substrate sample by cross-sectioning and using a scanning electron microscope (SEM) to observe the plated copper uniformity in drilled holes.

In Table 1 and Table 2, details of raw materials are provided below:
PPE resin: the product with model name NORYL SA9000 available from SABIC Company.
SBS resin: the product with model name SBS-Ctype available from Nippon Soda Company.
Crosslinking agent: TAIC available from Evonik Company.
Flame retardant: the product with model name PQ-60 available from Chin-Yee Chemical Industries Company.
Hollow spherical silica: the product with model name HS-200 available from AGC Company (Japan).
General spherical silica: silica prepared by a synthesis method, which is the product with model name EQ2410-SMC available from Third Age Technology (TAT) Company (China).
Hollow glass bead: the product with model name im16K available from 3M Company (Japan).
Coupling agent: the product with model name Z-6030 available from Dow Corning Company.
Peroxide: the product with model name Luperox F available from Arkema Company.

TABLE 1

| | | Comparative Examples | | |
|---|---|---|---|---|
| Items (Content: parts by weight) | | 1 | 2 | 3 |
| Raw | PPE resin | 50 | 50 | 50 |
| materials | SBS resin | 35 | 35 | 35 |
| | Crosslinking agent | 15 | 15 | 15 |
| | Flame retardant | 30 | 30 | 30 |
| | Hollow spherical | | | |
| | silica | | | |
| | General spherical | 52 | 52 | 52 |
| | silica | | | |
| | Hollow | | 1.3 | 1.3 |
| | glass bead | | | |
| | Coupling agent | 0.5 | 0.5 | 0.5 |
| | Peroxide | 0.5 | 0.5 | 0.5 |
| Evaluation | Glass transition | 205 | 209 | 208 |
| results | temperature (° C.) | | | |
| | Water absorption | 0.18 | 0.22 | 0.26 |
| | rate (%) | | | |
| | (PCT a half hour) | | | |
| | Heat resistance | Pass | Pass | NG |
| | (PCT a half hour) | | | |
| | Water absorption | 0.24 | 0.28 | 0.35 |
| | rate (%) | | | |
| | (PCT two hours) | | | |
| | Heat resistance | Pass | Pass | NG |
| | (PCT two hours) | | | |
| | Dk (10 GHz) | 3.06 | 3.00 | 2.81 |
| | Df (10 GHz) | 0.00180 | 0.00212 | 0.00293 |
| | Plated copper | Pass | Fail | Fail |
| | uniformity of | | | |
| | drilled hole | | | |
| | (Tolerance ± 20%) | | | |

TABLE 2

| | | Examples | | | |
|---|---|---|---|---|---|
| Items (Content: parts by weight) | | 1 | 2 | 3 | 4 |
| Raw | PPE resin | 50 | 50 | 50 | 50 |
| materials | SBS resin | 35 | 35 | 35 | 35 |
| | Crosslinking agent | 15 | 15 | 15 | 15 |
| | Flame retardant | 30 | 30 | 30 | 30 |
| | Hollow spherical | 1.3 | 6.5 | 13 | 19.5 |
| | silica | | | | |
| | General spherical | 52 | 52 | 52 | 52 |
| | silica | | | | |
| | Hollow | | | | |
| | glass bead | | | | |
| | Coupling agent | 0.5 | 0.5 | 0.5 | 0.5 |
| | Peroxide | 0.5 | 0.5 | 0.5 | 0.5 |
| Evaluation | Glass transition | 209 | 208 | 208 | 207 |
| results | temperature (° C.) | | | | |
| | Water absorption | 0.19 | 0.19 | 0.20 | 0.21 |
| | rate (%) | | | | |
| | (PCT a half hour) | | | | |
| | Heat resistance | Pass | Pass | Pass | Pass |
| | (PCT a half hour) | | | | |
| | Water absorption | 0.25 | 0.25 | 0.26 | 0.26 |
| | rate (%) | | | | |
| | (PCT two hours) | | | | |
| | Heat resistance | Pass | Pass | Pass | Pass |
| | (PCT two hours) | | | | |
| | Dk (10 GHz) | 3.00 | 2.92 | 2.86 | 2.78 |
| | Df (10 GHz) | 0.00180 | 0.00181 | 0.00183 | 0.00185 |
| | Plated copper | Pass | Pass | Pass | Pass |
| | uniformity of | | | | |
| | drilled hole | | | | |
| | (Tolerance ± 20%) | | | | |

It can be known from Table 1 and Table 2, the resin composition of Comparative Example 1 merely contains general spherical silica only, rather than hollow spherical silica, so that the Dk value of the result electronic material exceeds a limited range (2.75 to 3.05) and does not meet desired electrical properties. The resin compositions of Comparative Examples 2 and 3 additionally contains hollow glass beads to maintain the Dk value of the result electronic material can within the limited range. However, the hollow glass beads can not only cause poor plated copper uniformity of drilled hole but also an increase in Df value. In comparison, the resin compositions of Examples 1 to 4 use hollow spherical silica having a predetermined specific gravity and particle size in place of hollow glass beads, and use a PPE resin in combination with a SBS resin, thereby meeting low dielectric properties required for millimeter wave applications without lowering practically required characteristics, such as processability, moisture absorbance, heat resistance, fluidity, and resin filling property.

### Beneficial Effects of the Embodiments

In conclusion, by virtue of the resin system including 10 wt % to 60 wt % of a polyphenylene ether resin, 5 wt % to 30 wt % of a crosslinking agent, and 20 wt % to 50 wt % of a vinyl-containing elastomer, based on a total weight of the resin system, and the hollow spherical silica being in an amount from 1 phr to 20 phr and having a specific gravity between 0.4 g/cm³ and 0.6 g/cm³ and an average particle size (D50) between 2.0 μm and 3.0 μm, the low dielectric resin composition provided by the present disclosure can achieve excellent electrical properties (low Dk/low Df), moisture absorbance, and heat resistance while complying with halogen-free environmental protection requirements. Accordingly, the low dielectric resin composition can ensure stable performance on low transmission loss and exhibit good fluidity and resin filling property when used for manufacturing a laminated board, and is advantageous for improving drilling machinability and copper plating quality.

Furthermore, the low dielectric resin composition of the present disclosure serving as an electronic material adopting a polyphenylene ether resin is not only easy to be molded in combination with an electronic material adopting a thermosetting resin (e.g., an epoxy resin), but also adapted for the conventional manufacturing and processing equipment, thereby reducing costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A low dielectric resin composition for improvement of processability, comprising:
(A) a resin system including 10 wt % to 60 wt % of a polyphenylene ether resin, 5 wt % to 30 wt % of a crosslinking agent, and 20 wt % to 50 wt % of a vinyl-containing elastomer, based on a total weight of the resin system;
(B) a halogen-free flame retardant;
(C) hollow spherical silica having a specific gravity between 0.4 g/cm³ and 0.6 g/cm³ and an average particle size (D50) between 2.0 μm and 3.0 μm; and
(D) a coupling agent;
wherein, with respect to 100 phr of the resin system, an amount of the halogen-free flame retardant ranges from 20 phr to 45 phr, an amount of the hollow spherical silica ranges from 1 phr to 20 phr, and an amount of the coupling agent ranges from 0.1 phr to 5 phr;
wherein the low dielectric resin composition after being cured has a dielectric constant (Dk) between 2.75 and 3.05 and a dielectric loss factor (Df) of less than 0.002 at 10 GHz.

2. The low dielectric resin composition according to claim 1, wherein the vinyl-containing elastomer is selected from the group consisting of polybutadiene, styrene-butadiene copolymer, styrene-butadiene-styrene block copolymer, and styrene-butadiene-divinylbenzene copolymer.

3. The low dielectric resin composition according to claim 2, wherein the vinyl-containing elastomer is styrene-butadiene-styrene block copolymer that has a weight average molecular weight between 3500 g/mol and 5500 g/mol.

4. The low dielectric resin composition according to claim 3, wherein an amount of the styrene unit of the styrene-butadiene-styrene block copolymer is between 5 mol % and 40 mol %, and the styrene-butadiene-styrene block copolymer has a 1,2-vinyl content between 60 mol % and 90 mol % and a 1,4-vinyl content between 10 mol % and 40 mol %, based on a total vinyl content thereof being 100 mol %.

5. The low dielectric resin composition according to claim 1, wherein the hollow spherical silica is surface-modified by at least one of an acrylic group and a vinyl group.

6. The low dielectric resin composition according to claim 1, wherein the crosslinking agent is selected from the group consisting of 1,3,5-triallyl cyanurate (TAC), triallyl isocyanurate (TAIC), trimethallyl isocyanurate (TMAIC), diallyl phthalate, divinylbenzene, and 1,2,4-triallyl trimellitate.

7. The low dielectric resin composition according to claim 1, further comprising: (E) a general spherical silica having a specific gravity between 2.0 g/cm³ and 2.5 g/cm³, wherein, with respect to 100 phr of the resin system, an amount of the general spherical silica is 50 phr to 95 phr.

8. The low dielectric resin composition according to claim 1, wherein the general spherical silica has an average particle size (D50) between 2.0 μm and 3.0 μm.

9. The low dielectric resin composition according to claim 1, wherein halogen-free flame retardant is a compound having the structure represented by formula (I): 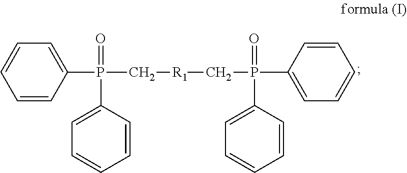
wherein R₁ represents a covalent bond, —CH₂—, 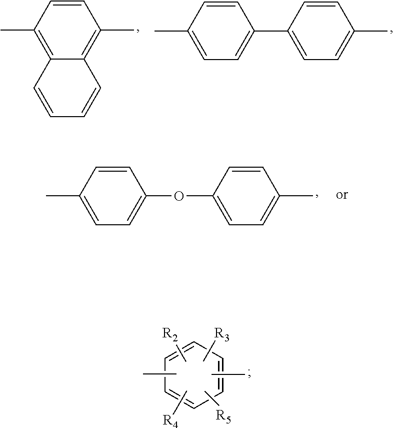
wherein R₂, R₃, R₄, and R₅ each independently represent a hydrogen atom, an alkyl group, or

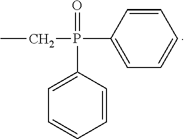 [SMILES: CCP(=O)(c1ccccc1)c1ccccc1]

10. A prepreg prepared by coating or impregnating a reinforcing material with the low dielectric resin composition as claimed in claim 1.

11. A metal clad laminate prepared by laminating the prepreg as claimed in claim 10 to a metal layer.

12. A metal clad laminate prepared by coating the low dielectric resin composition as claimed in claim 1 on a metal layer.
